(19) United States
(12) Patent Application Publication
(10) Pub. No.: US 2026/0109323 A1
(43) Pub. Date: Apr. 23, 2026

(54) Control of Access to a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/361,135

(22) Filed: Oct. 17, 2025

(30) Foreign Application Priority Data
Oct. 18, 2024 (DE) 10 2024 130 389.1

(51) Int. Cl. B60R 25/24

(52) U.S. Cl. CPC B60R 25/241; B60R 2325/202; B60R 2325/205

(57) ABSTRACT

A method for controlling an access to a motor vehicle comprises a transmission of a first command message with respect to an administrative access to a digital vehicle key for the motor vehicle, which key is saved on a memory card; a reception and relaying of a forward message of a message exchange; a reception and relaying of a return message of the message exchange; and a reception of a confirmation message with respect to the administrative access executed.

### CROSS REFERENCE TO RELATED APPLICATION

This application claims priority under 35 U.S.C. §119 from German Patent Application No. DE 102024130 389.1, filed October 18, 2024, the entire disclosure of which is herein expressly incorporated by reference.

### BACKGROUND AND SUMMARY

The invention relates to a technology for controlling access to a motor vehicle. This technology comprises, inter alia, administrative access to a digital vehicle key for the motor vehicle, where the key is saved on a memory card. The invention can be implemented, for example, on a mobile device, a memory card and a server in a backend application for the motor vehicle.

A motor vehicle can be secured by means of a concept which has been introduced in the form of a “Digital Car Key” (DCK) of the “Car Connectivity Consortium” (CCC). A comprehensive technical description is included, for example, in the technical specification “Digital Key Release 3”. According to this concept, it is provided that a security function of the motor vehicle, for example a central locking system and/or an immobilizer, is controlled on the basis of an asymmetric cryptographic method. A digital vehicle key, in the form of a cryptographic data structure, can be assigned to a user. For authentication on the basis of this key, a wireless connection is employed, for example between a mobile device and the motor vehicle.

A digital vehicle key, for example, can comprise a private and a public element. The private element can be saved in a secure environment of the mobile device. Conversely, a digital key is assigned to the motor vehicle, the private element of which can be saved in an on-board controller. A public element is known to a user. For the control of a security or access function, a bilateral authentication is executed on the basis of the respective private and public key components. In the event of successful authentication, a requested security function is controlled on the motor vehicle, access to, or an operation of the vehicle is enabled, etc.

It is known that a digital vehicle key can not only be saved on a mobile device, but also on a smartcard, wherein, for example, an NFC (Near Field Communication) technology is employed for interaction with the motor vehicle.

According to the CCC, for example, an endpoint can be generated on the smartcard. It is intended that, during a manufacturing process, an administration should be enabled wherein, for example, an endpoint is updated using information which is sourced, for example, from an attestation package which is received from a server in a backend application for the vehicle. Further to the completion of a corresponding initial activation phase, i.e. immediately the smartcard is no longer exposed to the corresponding NFC field, however, it is intended that administration of the endpoint should no longer be readily possible, i.e. the endpoint should be protected against indiscriminate manipulations.

With respect to a smartcard on which a digital vehicle key is saved, or on which multiple such keys are saved, a general requirement exists for the prevention of any deletion or editing of these keys by unauthorized parties, wherein it is intended that corresponding preventative measures should be as simple as possible to implement.

A fundamental object of the present invention is the provision of an improved concept for a technology for controlling access to a motor vehicle. According to the invention, this object is fulfilled by the subject matter of the independent claims. Preferred embodiments are disclosed in the subclaims.

A first aspect of the present invention relates to a method for controlling access to a motor vehicle. The method can be user-implemented or device-implemented, for example on a mobile device of a person who intends to execute the administration of a digital vehicle key on a memory card. The method comprises a transmission of a first command message with respect to an administrative access to a digital vehicle key for the motor vehicle, which key is saved on a memory card; a reception and relaying of a forward message of a message exchange; a reception and relaying of a return message of the message exchange; and a reception of a confirmation message with respect to the administrative access executed.

A second aspect of the present invention relates to a further method for controlling access to a motor vehicle. The method can be implemented, for example, on a memory card, and executed during an activation cycle, i.e. in the event that the card is exposed to a sufficient activation field. The method comprises a reception of a first command message with respect to an administrative access to a digital vehicle key for the motor vehicle, which key is saved on a memory card; a transmission of a forward message of a message exchange; a reception of a return message of the message exchange, wherein the return message contains a return signature; a checking of the return signature vis-à-vis a saved certificate; and, on the basis of the check of the return signature, a transmission of a response message with respect to administrative access (in particular, the response message can be a confirmation message with respect to the administrative access executed).

A third aspect of the present invention relates to one further method for controlling access to a motor vehicle. The method can be implemented, for example, in a backend application for the vehicle, a key management function, etc. The method comprises a reception of a forward message of a message exchange, wherein the message exchange relates to an administrative access to a digital vehicle key for the motor vehicle, wherein the digital vehicle key is saved on a memory card, and wherein the forward message contains a forward signature; a checking of the forward signature vis-à-vis a saved certificate with respect to the memory card; and, on the basis of the check of the forward signature, a transmission of a return message of the message exchange.

Embodiments of the invention provide a concept or framework for the protection of a digital vehicle key (or multiple such keys) which are saved on a memory card against unauthorized manipulations. An administration, for example of an endpoint for a digital vehicle key, is not readily possible, i.e. the endpoint is protected. According to forms of the invention, a release function (release process, or similar) is executed upstream of each administrative function (administrative access). Release or authorization is valid for a specific administrative access or administrative order, or for multiple different orders of this type. Any administration of a digital vehicle key in response to an order or a command which does not enact a release will be rejected.

Embodiments according to the invention can be implemented with limited complexity, and only increase complexity vis-à-vis known administrative technologies to a minimal extent. Embodiments according to the invention require no laborious and complex authentication of a user, and are consequently simple to employ.

In some embodiments according to the invention, the release process comprises an exchange of messages (“handshake”) between the memory card and a server, for example in a vehicle-side backend application, wherein the mobile device functions as a relay station therebetween.

Administrative access can involve, for example, an editing, an overwriting and/or a deletion of a digital vehicle key, or (for example in a CCC-based scenario), an editing, an overwriting and/or a deletion of a memory card-based endpoint for a digital vehicle key.

A memory card can be, for example, a plastic card, a chip card, a smartcard, etc. having an integrated circuit (chip), a hardware logic circuit, a memory and/or a microprocessor. Rather than a card in a bank card format, the memory card might also be provided in the form of a stick, a fob or a token, etc., and thus provided, for example, in the form of a HW token having a format or form factor such as a USB token.

A “mobile device” is to be understood herein as a tablet or smartphone, a smartwatch, smart band, smart ring etc. or, in general, any device by means of which access is obtainable to a memory card, smartcard, etc. (or to multiple memory cards, either sequentially or in parallel), for example by means of NFC technology, or by means of Bluetooth, Bluetooth Low Energy, etc.

The mobile device can also be a device on which a digital vehicle key can be saved, and which can be employed for accessing a motor vehicle. A combination might also be employed of a set comprising a mobile device and at least one smartcard, wherein the smartcard is employed as a second key. It is then intended that the mobile device should be enabled for the administration of the memory card, more specifically for the administration of the digital vehicle key which is saved on the memory card.

The message exchange partner can be a server in a vehicle-side backend application, and thus a server which is operated by a manufacturer of the vehicle, or by another party such as, for example, an organization such as the CCC or, in general, a management organization or entity – in general, a key management authority. This entity can thus constitute a management-side structure, for example a PKI (Public Key Infrastructure), a CA (Certificate Authority), etc.

According to some embodiments of the first aspect of the invention, relaying of the forward message comprises a signature of the forward message with a cryptographic key, which key can function, for example, as a device key, and is securely saved on a mobile device. This results in a further enhancement of security, in the event that administrative access to a memory card is only enabled by means of a corresponding cryptographic key, which key is saved on the device which is employed for administration. A key of this type can be registered, for example, in a vehicle-side backend application, for example in association with a mobile device of a vehicle owner.

Some embodiments of the first aspect of the invention moreover comprise a reception of a confirmation message with respect to the message exchange executed, and a transmission of a second command message with respect to administrative access to the memory card. According to some of these embodiments, by means of the first command message, a command can be transmitted for the general enablement of an administration function and, further to a successful release, by means of the second command message, a specific and desired administrative command can be transmitted. Such embodiments enable the invention to be implemented with minimal intervention in existing processes.

According to some of these embodiments, mobile devices can assume different entitlements, security levels, etc., such that, for example, a mobile device (for example of a private user) assumes an entitlement for the deletion of an endpoint, but not for the editing or overwriting thereof, whereas another entitlement (for example of an administrative user) also enables an edit and overwrite function.

According to some embodiments of the second aspect of the invention, the saved certificate is a trusted certificate. A certificate of this type can be incorporated, for example, in-factory or in conjunction with the manufacture of a memory card (for example, by “certificate pinning”). Security can thus be optimized wherein, for example, any transmission of a certificate of this type is generally avoided. The trusted certificate thus incorporated can then be employed, in turn, for optimizing the security of the message exchange and, for example in the event of any compromise, for enabling a re-establishment of a chain of trust. According to some embodiments, for the purposes of signature, it is thus preferred that, predominantly or exclusively, derivative or intermediate certificates are employed.

According to some embodiments of the second aspect of the invention, the forward message contains a forward signature. This signature enables the recipient of the forward message to execute a check of the forward message, i.e. a verification to the effect that the forward message originates from a memory card which is known, for example, in a vehicle-side backend application. According to some of these embodiments, the forward message contains a forward chain of trust; this chain of trust can then be verified by a recipient of the forward message, thus enabling a flexibility in the construction of a PKI, for example for the memory card and/or the message exchange partner, etc.

The forward signature can comprise a signature which is based upon a trusted certificate, a trusted CA or a root element which is applied to the memory card, for example in-factory. According to this embodiment, the chain of trust can comprise, for example, a certificate with respect to the signature key, and (at least) one intermediate certificate which refers to a trusted certificate which, for example, is not included in the chain of trust transmitted.

According to some embodiments, the forward signature can relate to a single-use element of information (“nonce”) which, at the end of the message exchange, is to be referred back to the memory card for the purposes of verification. Embodiments of this type can contribute to a simple and reliable release, enablement or authorization process.

According to some embodiments of the second aspect of the invention, the return message contains a return chain of trust, and a checking of the return message can comprise a check of the return chain of trust. If this check or verification is executed by a memory card, a resulting flexibility is thus enabled in the construction of a PKI, for example for the message exchange partner. This can involve, for example, a certificate structure of a vehicle-side backend application, or a CA which is provided and/or operated by the CCC, etc.

Some embodiments of the second aspect of the invention comprise a transmission of a confirmation message with respect to the administration of the endpoint. Thus, for example, a successful message exchange can be confirmed with respect to a general authorization. This authorization can comprise a command for a specific administrative access, or multiple such commands. Additionally or alternatively, the authorization can comprise an administrative access to a digital vehicle key, or to multiple or, for example, to all the digital vehicle keys (or corresponding endpoints) which are saved on the memory card).

Some of these embodiments can comprise the reception of a second command message, wherein the second command message relates to a specific administration of an end. The corresponding command can be, for example, a specific command for the editing, overwriting or deletion of an endpoint or of a digital vehicle key.

According to some embodiments of the third aspect of the invention, the saved certificate is a trusted certificate. A certificate of this type can be present, for example, in a management-side server which is hosted in a secure and hardened environment. Security can thus be optimized wherein, for example, a transmission of this certificate in a preparatory process, in the message exchange itself, in a production process for the memory card, or by any other means, is avoided. Instead, derivative or intermediate certificates can be employed for signature.

According to some embodiments of the third aspect of the invention, the return message contains a return signature. This enables the recipient of the return message to execute a check of the return message, i.e. a verification to the effect that the return message originates from an authorized management entity (or agency, or authority) which is known, for example, to the memory card in-factory. According to some of these embodiments, the return message contains a return chain of trust, which chain of trust can then be verified by a recipient of the return message, thus enabling a flexibility in the construction of a PKI, for example for the memory card and/or the other message exchange partner, etc.

The return signature can comprise a signature of a key management authority. According to these embodiments, the chain of trust can comprise, for example, a certificate with respect to a signature key, and at least one intermediate certificate which refers to a trusted certificate, which certificate, for example, is not included in the chain of trust transmitted.

According to some embodiments, the return signature can relate to a single-use element of information (“nonce”) which has been signed and transmitted by the memory card. Further to the verification of the signature by the key management function, this signed nonce can receive a further signature and, in this form, is returned to the memory card for the purposes of verification. The message exchange is completed accordingly. Embodiments of this type enable the construction of simple and reliable release processes.

According to some embodiments of the third aspect of the invention, the forward message contains a second signature, wherein the second signature relates to a device key, or similar, which is securely saved on the mobile device. The method executed by the key management function then comprises a checking of the second signature, and a transmission of the return message of the message exchange is executed on the basis of the check of the second signature. For the purposes of checking, for example, a certificate with respect to the device key is saved in the backend application/key management function, or a saving thereof is executed, for example during an installation of an app for a key management function on the mobile device, a registration of the mobile device for administrative purposes in the backend application, etc.

Embodiments of this type enable a checking and confirmation as to whether a mobile device is authorized for administrative access. According to some of these embodiments, an administrative access can be conferred in accordance with this check.

A further aspect of the present invention relates to a mobile device, which device is configured for controlling an access to a motor vehicle according to method which is described herein. On the mobile device, a software or an application (“app”) can be installed which enables the user to access a device-side key management function (administration) of a digital vehicle key which is saved on a memory card. The app can be provided, for example, by a manufacturer of the vehicle or of the mobile device, or by a third party entity (for example the CCC).

The mobile device can comprise a secure environment (for example, based upon a corresponding cryptoprocessor, etc.). The secure environment can be configured for saving a device key, a digital vehicle key, a corresponding endpoint, etc.

On the mobile device, a PKI or a “root element” such as, for example, a certification authority, an agency, a certification entity, a CA (for example a root CA), etc., can be present for outputting certificates (the root element can also comprise, or exclusively comprise a cryptographic key, a private key component, a certificate, etc.). The secure environment can be configured for saving a plurality of digital certificates, for example of intermediate certificates, CA entity certificates, etc.

One further aspect of the present invention relates to a memory card which is configured for controlling an access to a motor vehicle according to a method described herein. In particular, the memory card can comprise storage facilities for saving at least one digital vehicle key and thus, for example, a data structure such as, for example, an endpoint according to the CCC for a digital vehicle key. The memory card can comprise storage capacities for saving at least one certificate, for example one or more trusted certificates, certificates which are derived therefrom, etc.

The memory card can comprise processor capacities, in order to enable the processing of commands received for the administration of saved data structures, such as the one or more digital vehicle keys. These commands can comprise general commands for authorization, and commands for a specific administrative access.

One further aspect of the present invention relates to a server, for example in a vehicle-side backend application, for a key management function, etc., wherein the server is configured for controlling access to a motor vehicle, according to a method described herein. The server can also comprise multiple servers, a server landscape, etc. The server can be operated, for example by a manufacturer of the vehicle, or otherwise operated by an operator of the key management function, an administrative authority, etc. On the server, a software can be installed, which software enables an administrative control, a control of a key management function, in particular of an access to a memory card further to the manufacture and delivery thereof to a customer, user, owner etc. of the motor vehicle.

Another further aspect of the present invention relates to a system for controlling an access to a motor vehicle. The system comprises the motor vehicle, a mobile device described herein, at least one memory card described herein, and a backend server described herein. The vehicle can be configured for saving a digital vehicle key, including a derivative vehicle key. The mobile device can be configured for administrative access to the memory card(s). All entities in the system cooperate in the interests of the secure administration of the digital vehicle key which is saved on the memory card

A further aspect of the present invention relates to a combination comprised of a motor vehicle and at least one memory card which is described herein, on which memory card a digital vehicle key for the motor vehicle is saved. For example, the memory card, or each memory card, can function as a second key.

The invention is described in greater detail with reference to the attached drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a system;

FIG. 2A shows a flow diagram of a first method;

FIG. 2B shows a flow diagram of a second method;

FIG. 2C shows a flow diagram of a third method;

FIG. 3a and FIG. 3b collectively illustrate a flow diagram of a fourth method.

### DETAILED DESCRIPTION OF THE DRAWINGS

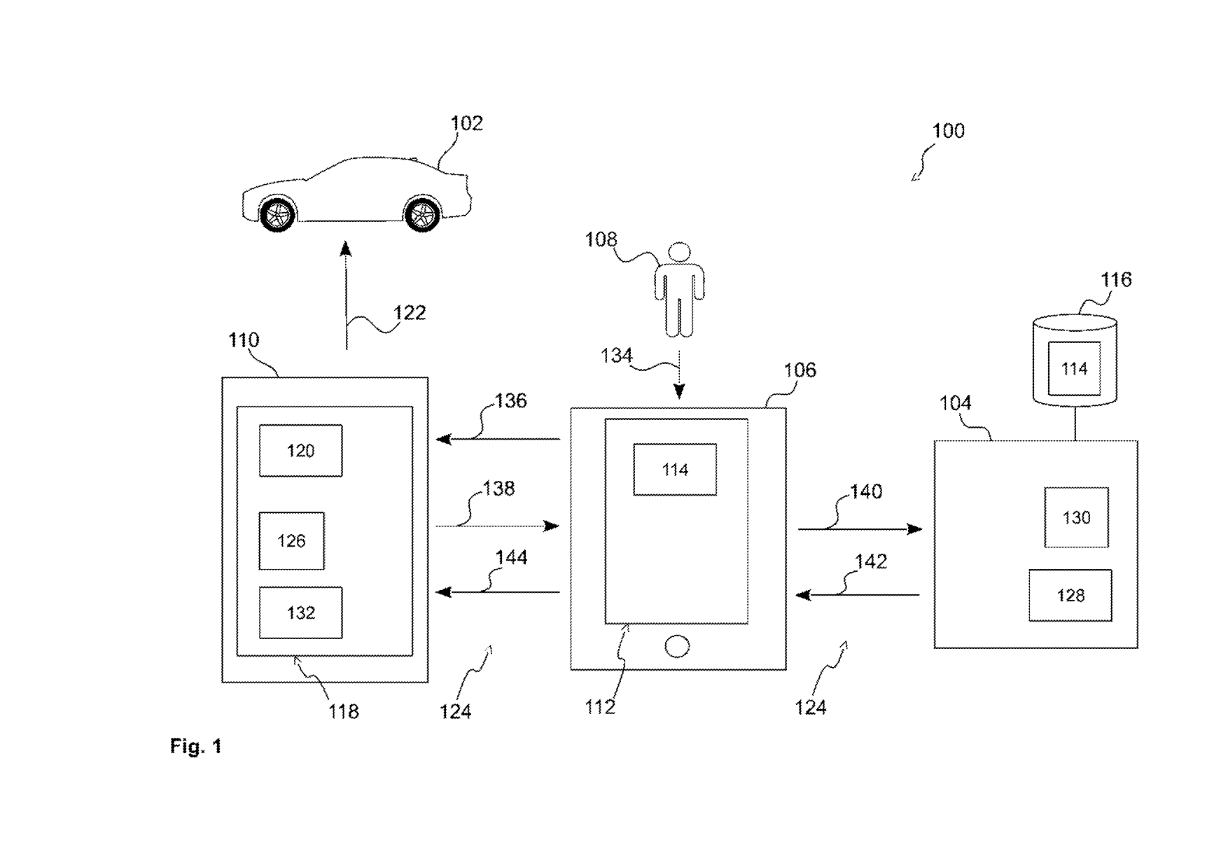

FIG. 1 shows a schematic representation of a system 100 having a motor vehicle 102, a server 104 in a backend application for the vehicle 102, a mobile device 106 of a user 108, and a smartcard 110.

Hereinafter, the reference number “104” is employed for the general designation of an or the backend application 104 (in particular for the motor vehicle 102), and is also employed for the specific designation of the server 104, wherein the server 104 can also comprise a plurality of interconnected servers, for example a server of an administrative owner or operator of the vehicle 102 (wherein the vehicle 102, for example, can be included in a vehicle fleet), a server of a manufacturer of the vehicle 102 (for example for a service of a key management function or a technical key management function, which service, however, can also be operated independently, for example by a suborganization of the CCC), a server of a manufacturer of the mobile device 106, etc.

The mobile device 106 has access to at least one secure environment 112, which environment can comprise, for example, a secure element, a secure enclave, a TEE, etc. The secure environment 112 can be operated, for example, by a cryptographic processor. In the secure environment 112, for example, an (unrepresented) digital vehicle key for the vehicle 102 can be saved, together with a user or device key 114, by means of which, for example, the device 106 can be assigned to a user profile 116 of the user 108 in the backend application 104. The user profile might indicate the user 108, for example by way of the owner of the vehicle 102, and the mobile device 106 might be the private property of the user 108, or the user 108 might be a commercial or administrative owner who operates a vehicle fleet which includes the vehicle 102, wherein the mobile device 106 is operated by an employee of the owner.

On occasions, in the interests of brevity, the smartcard 110 is also simply designated herein as a “card” 110, wherein the smartcard 110 can also be a token, a fob, etc. The card 110 contains a secure memory area 118, in which a digital vehicle key 120 for access 122 to the vehicle 102 is saved. Access 122 can be executed, for example, by means of NFC technology, and can involve access to a central locking system or a drive motor of the vehicle 102.

According to a specific exemplary embodiment, the user 108 has purchased the smartcard 110, and has saved the digital key 120 on the card 110. At a later date, it might be intended that this key 120 is replaced by another, or that the key 120 is deleted. According to another exemplary embodiment, the user 108 might wish to edit properties of the digital key 120 on the smartcard 110. According to a further exemplary embodiment, a fleet operator or service provider prepares multiple smartcards having digital keys in the context of a delivery of multiple vehicles and, further to the execution of delivery, might intend to overwrite keys on smartcards which are no longer required, or to delete all keys on the respective card.

According to some exemplary embodiments, during a production, equipment or supply process of the card 110, an endpoint can be generated on the card 110, i.e. a data structure according to the CCC, which data structure represents the digital vehicle key 120. On occasions, according to such exemplary embodiment, in the interests of clarity, reference is made to the vehicle key 120 or the endpoint 120 only; in each case, the endpoint is signified which represents the digital vehicle key 120 (and, optionally, further information relating to the key 120).

It is intended that the smartcard 110, during a manufacturing process and an initial activation phase, should enable a saving of the key 120, and an activation of the key 120 in the vehicle 102. Immediately the initial activation phase is terminated, i.e. immediately the corresponding NFC field has decayed, it is intended that an administration should no longer be readily possible, i.e. that the endpoint 120 is protected. To this end, according to the invention, it is provided that a release or authorization process is executed upstream of each administrative access, wherein a release relates to a specific administrative command or multiple commands, and other commands are not permitted or executed.

In the event that the user 108, by means of the mobile device 106, wishes to edit or delete the endpoint 120 for the digital key, or to execute the overwriting thereof with a new key, according to some exemplary embodiments, a command or order is issued to the card, for example an APDU (Application Protocol Data Unit) command, in order to initiate the release process. The command can be an explicit and specific command which relates to the initiation of the release process. However, the command can be issued implicitly, wherein the specific command for the specific administrative access is cancelled.

As indicated, according the invention, a release function or process is executed upstream of an, or of any administrative access. Any attempted access using a command which has not been released will be rejected. A malfunction of the release process will also result in an interruption.

According to a number of the exemplary embodiments illustrated with reference to FIG. 1, the release process comprises a message exchange (handshake) 124 between the memory card 110 and the server or backend application 104. A successful message exchange 124 signifies that the mobile device 106 is authorized for the set down or transmission of a command with respect to an administrative access to the card 110 or the endpoint 120, i.e. the command is received and executed by the smartcard 110.

From a specific perspective, which is not to be understood by way of limitation, a requisite entity or agency (authority) for authorization can be located in the backend application 104, for example a key management function for the vehicle 102. For example, the key management function can access the user profile 116, in order to establish whether the device 106 is authorized for a specific administration operation, and thus e.g. for a deletion of the key 120 from the card 110 (for example, if the user 108 is a private user), or for an editing or overwriting of the key 120 on the card 110 (for example, if the user 108 is a fleet management administrator).

From a different or supplementary perspective which, likewise, is not to be understood by way of limitation, by means of the message exchange 124, authorization can be transferred or outsourced from the card 110 to the backend application 104. To this end, a PKI or a root element 126 is provided in the card 110. A certificate 128 with respect to the card 110 or the root element 126 is saved in the backend application 104. The certificate 128 can be saved in the backend application 104, in conjunction with the manufacture or supply of the card 110.

The certificate 128 can be employed to verify a signature of the CA 126 in the backend application 104. More specifically, the smartcard 110 can employ a signature key, the signature of which is verifiable in the backend application 104, namely on the grounds that the certificate 128 is saved therein. Conversely, in the backend application 104 a root element 130 can be provided which is identified in the smartcard 110 by means of a corresponding certificate 132.

It is hereby observed that, according to preferred exemplary embodiments, only the respective trusted certificates 128 or 132 of the respective partner (the card 110, or the backend or key management application 104) are known such that, in the event of any compromise, a re-establishment of intermediate levels is enabled. Consequently, the respective signatory entity (for example, the card 110 or the backend application 104) transmits the respective chain of trust (certificate chain) to the verifying partner (for example, the backend application 104 or the card 110). The signature key can be represented, for example, by a leaf certificate, which leaf certificate, for example by reference to an intermediate certificate (or multiple such certificates) can be validated vis-à-vis the saved certificate (validation of the chain of trust).

With further reference to FIG. 1, the message exchange 124 includes a user input 134 of the user 108, in response to which the mobile device 106 initiates the transmission of a command 136 to the smartcard 110. The command can be an APDU command for a release or authorization of an endpoint administration. The command can either be a generic command, for example an authorization request such as “AUTHORIZE MANAGEMENT REQUEST”, or the desired specific command can be transmitted, for example “DELETE ENDPOINT”. The requested scope of validity of authorization might only include one endpoint, for example “AUTHORIZE ENDPOINT MANAGEMENT REQUEST” such that, for each endpoint which is to be administered, a message exchange with the backend application 104 is required, or a common administration operation can be requested for multiple, or for all the endpoints which are saved on the card 110. An authorization thus requested and conferred can be valid, for example, during an activation cycle, i.e. for such time as an NFC field is active. To this end, for any further or different administration, it is necessary for the execution of a release or authorization process to be repeated in a further or subsequent activation cycle.

With respect to this process, the smartcard 110 firstly generates a test or trial (challenge). To this end, the smartcard 110 generates a single-use element of information (nonce). This nonce is signed by the root element 126 on the card 110. The nonce thus signed is transmitted to the mobile device 106, as indicated by the arrow which carries the reference number 138, and is relayed 140 from the mobile device 106 to the vehicle backend application or, in general, to a key management function 104, in combination with the certificate of the signatory key and the intermediate certificates thereof (chain of trust).

In the interests of optimum security, it can moreover be ensured that an administration operation with respect to the smartcard 110 or the key 120 is only permissible by means of a valid digital key on the mobile device 110. To this end, the relayed 140 forward message can be signed using the device key 114 of the mobile device 106. As described, although the device key 114 might be employed for the registration of the mobile device 106 in the backend or key management application 104, it is also conceivable that the key 114 is considered, for example, as a key for administrative purposes, i.e. as a key which is specifically enabled for administrative access on the smartcard 110.

The vehicle-side backend or key management application 104 verifies the test 140 thus received with respect to the card 110, i.e. the backend application 104 checks the signature of the nonce vis-à-vis the root element 126 of the card 110 which is known from the certificate 128, including the chain of trust thus transmitted 140. The signature of the device key 114 is also checked.

According to one exemplary embodiment, the root element 126 can refer to a certificate which, for example, has been directly introduced by a card manufacturer, and is thus, for example, an anchor certificate (a pinned certificate, or trust anchor). According to another exemplary embodiment, the root element can relate to a CA in the card 110, wherein the card 110 can then generate a signature certificate, and the test signed-off by means thereof. In this case, it is possible that the backend application 104, for example, might only have identified or countersigned (cross-signed) a CA certificate of the card manufacturer or of a training station.

According to one exemplary embodiment, verification of the signature of the test, on the basis of the trusted certificate 128 which is saved in the backend application 104, is only executed to the extent of an anchor certificate, or a certification chain might extend from a root CA to a requisite level of the anchor certificate. According to another exemplary embodiment, verification of the signature of the test might include verification to the extent of a backend root CA.

As a general observation, all the certificates described herein are not necessarily required to comply with a formatting specification such as, for example, the X.509 standard. It is sufficient that, for example using the certificate 128 or 132, the respective partner in the message exchange 124 can be verified, more specifically the respective root element 126 or 130.

In the event of successful verification, the backend application 104 executes a further signature of the signed nonce thus received, and transmits 142 a corresponding return message to the mobile device 106. From thence, the return message is relayed 144 to the card 110. Specifically, relaying 144 can be executed in the form of an APDU response command, i.e. for an administration of the endpoint 120 (in general, of a single endpoint) for example in the form of an APDU “AUTHORIZE ENDPOINT MANAGEMENT RESPONSE”.

The Smartcard 110 checks the signature of the backend application 104, more specifically of the CA entity 130 (on the basis of the certificate 132 and a co-supplied chain of trust 144) and, in the event of a positive outcome of this check, confers an administrative access to the desired endpoint (or to the desired endpoints). It is conceivable that the access conferred does not correspond to the desired access; for example, the card 110 might not execute the command which is intended by the user 108, or enable the release thereof for execution, such as e.g. an overwriting of the endpoint 120, but might only execute a deletion of the endpoint 120, or enable the release thereof for execution 120.

The authorization status conferred can be maintained for the current session or the current activation cycle, or a further or different release process can be initiated.

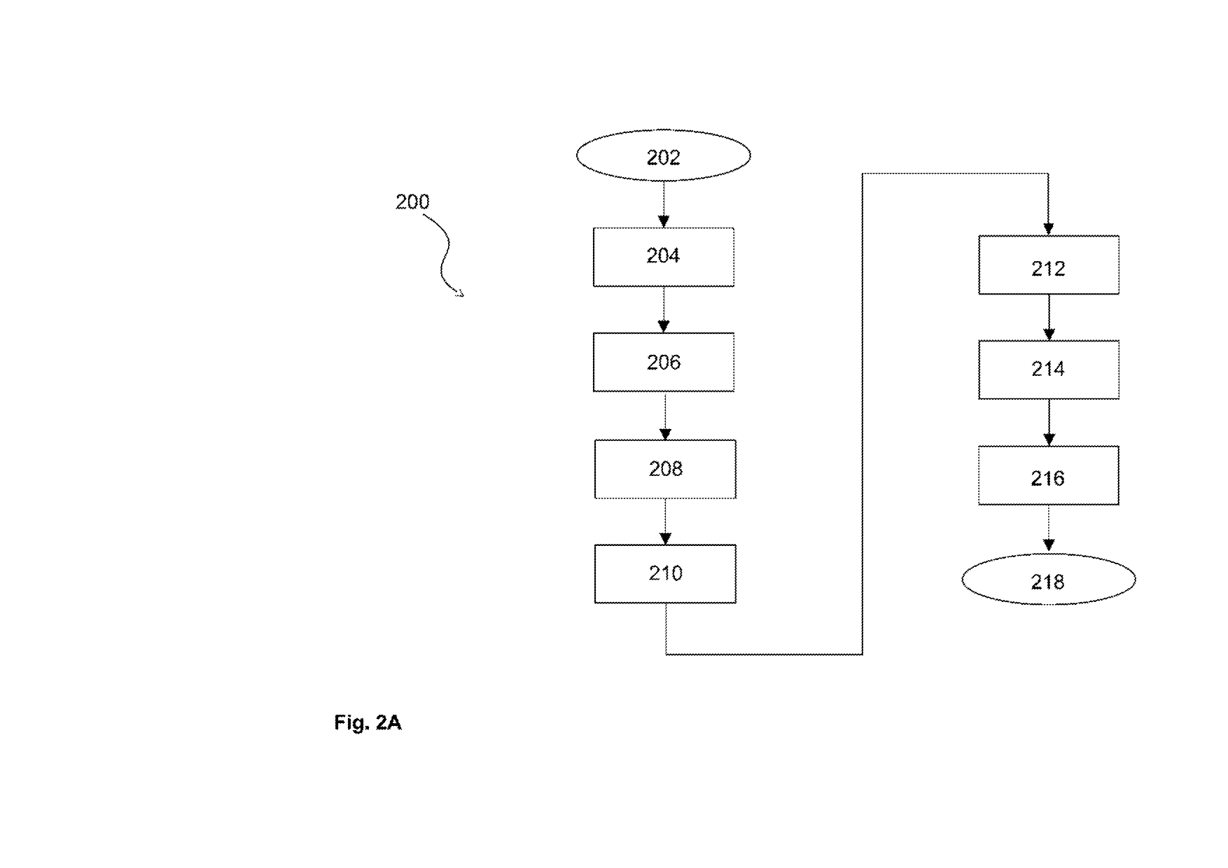

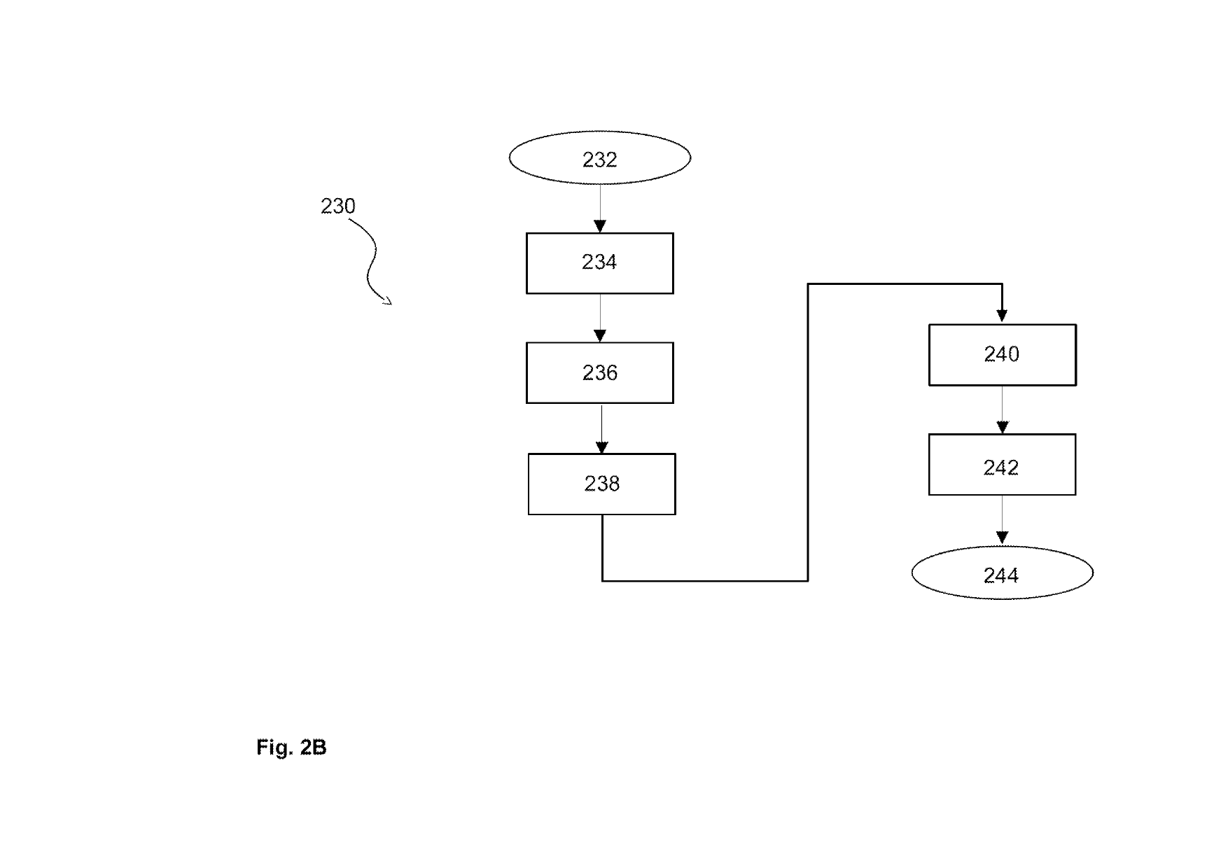

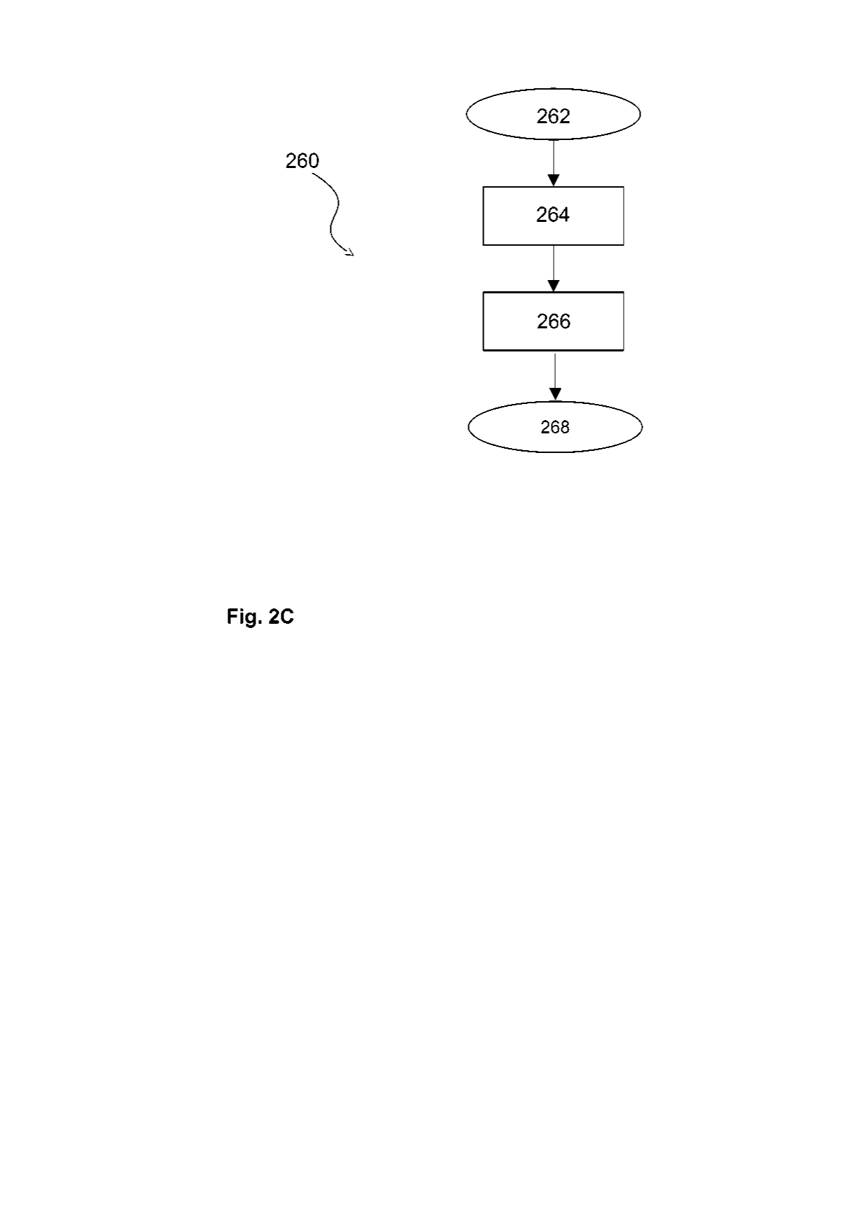

A specific exemplary embodiment of an interaction between the smartcard 110, the mobile device 106 of the user 108 and a backend or key management application 104 for a secure administration of the digital vehicle key 120 on the smartcard 110 is described in greater detail hereinafter with reference to the sequences which are schematically represented in FIGS. 2A, 2B and 2C. FIG. 2A shows a sequence of a method 200 for controlling an access to the motor vehicle 102 in the mobile device 106. FIG. 2B shows a sequence of a corresponding method 230 on the smartcard 110 in the backend application 104. FIG. 2C shows a sequence of a corresponding method 260 in the backend application 104.

It should be observed that the method 200 according to FIG. 2A can be executed in the mobile device 106, but also, in part, in a backend application for the mobile device 106; in the interests of clarity, however, this issue is not addressed in any further detail hereinafter. It should further be observed that any communication described hereinafter between the mobile device 106 and the backend application 104 can employ a cellular radio-based connection or multiple cellular radio-based connections, and/or short-range wireless connections wherein, for example, the vehicle 102 can be employed as a relay station for the relaying of communication between the mobile device 106 and the or a backend server 104. Again, in the interests of clarity, this issue is not addressed in any further detail in the following description.

In the method 200 according to FIG. 2A, the sequence commences with a step 202, in which a first command message is transmitted by the mobile device 106 to the smartcard 110, wherein the command message relates to a request for authorization for administrative access to the digital vehicle key 120 for the vehicle 102, which key is saved on the memory card 110.

Correspondingly, in a step 232 of the method 230 according to FIG. 2B, the first command message is received in the smartcard 110. In response thereto, the message exchange 124 with the backend application 104 is initiated. Specifically, in a step 234, a forward message of the message exchange 124 is transmitted. The forward message can contain a forward signature. The forward signature can be applied as a signature of the nonce. The signature can be signed by the root element 126. The forward message can contain a forward chain of trust, wherein at least one certificate relates to or represents the signature key of the forward signature.

In a corresponding step 204 (of the method 200 according to FIG. 2A) the mobile device 106 receives the forward message transmitted by the smartcard 110 and, in a step 206, executes the relaying of to the backend application 104. Relaying of the forward message can comprise a signature of the forward message using the administrative key, or user key, or device key 114, which key is saved in the secure environment 112 of the mobile device 106.

Correspondingly, in a step 262 of the method 260 according to FIG. 2C, the forward message is received in the backend application 104. In a step 264, the forward signature of the forward message is checked vis-à-vis the saved certificate 128 which relates to the memory card 110 (more specifically, the root element 126).

In a step 266 which can be executed in tandem with, prior to or subsequently to step 264, the backend application 104 checks the further signature of the forward message which relates to the device key 114.

If the checks in steps 264 and 266 both proceed positively, in a step 268, a signed return message of the message exchange 124 is transmitted. The return message contains a return signature. In particular, the return message can relate to the nonce which is transmitted and signed by the smartcard 110, which nonce is expanded by the inclusion of a further signature (return signature), namely, by the root element 130 in the backend application 104. The return message can moreover contain a further chain of trust, wherein at least one certificate relates to or represents the signature key of the return signature.

Correspondingly, in a step 208 of the method 200 according to FIG. 2A, the return message is received in the mobile device 106. In a step 210, the return message is relayed to the smartcard 110.

Correspondingly, in a step 236 of the method 230 according to FIG. 2B, relayed return message is received by the mobile device 106. In a step 238, the return signature of the return message is checked vis-à-vis the saved certificate 132 (with respect to the root element 130 in the backend application 104). Checking of the return message also includes a check of the co-transmitted return chain of trust.

If this check proceeds positively, the smartcard 110, in the sequence according to FIG. 2B, in a step 240, delivers a corresponding return message to the mobile device 106, i.e. communicates an authorization which corresponds, for example, to the request received in step 232 with respect to an authorization for the administration of the endpoint 120.

Correspondingly, in a step 212 of the method 200 according to FIG. 2A, the confirmation message with respect to the message exchange executed, and the authorization which is based thereupon, are received in the mobile device. In response thereto, the mobile device 106 in a step 214 transmits a second command message to the smartcard, which message relates to a specific administrative access on the memory card 110; more specifically, the command relates to a specific administration of the endpoint 120 on the smartcard 110 and thus, for example, to an editing, deletion or overwriting of the relevant digital vehicle key.

Correspondingly, in a step 242 of the method 230 according to FIG. 2B, the second command message is received, and the corresponding administration of the endpoint 120 is executed, provided that this execution is included in the authorization. In a step 244, a response message with respect to the administrative access executed is transmitted to the mobile device 106.

Correspondingly, in a step 216 of the method 200 according to FIG. 2A, the confirmation message with respect to the administrative access executed is received in the mobile device 106, and a corresponding output is generated on a user interface of the mobile device 106 for the attention of the user 108. Administration of the key 120 on the smartcard 110 is concluded accordingly. If, for example, a digital vehicle key for the vehicle 102 has been saved on the smartcard 110 (for example by means of editing or overwriting), the vehicle 102 can now be accessed by means of the smartcard 110.

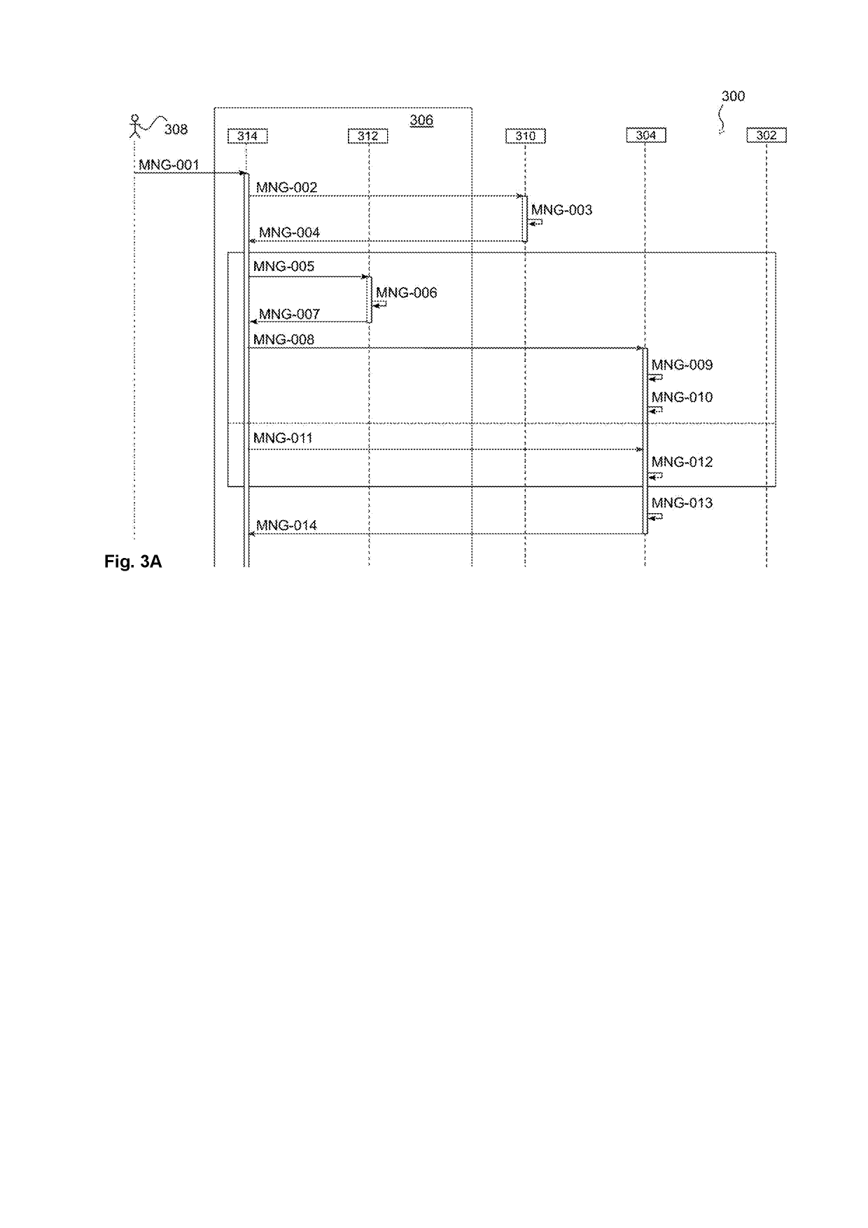

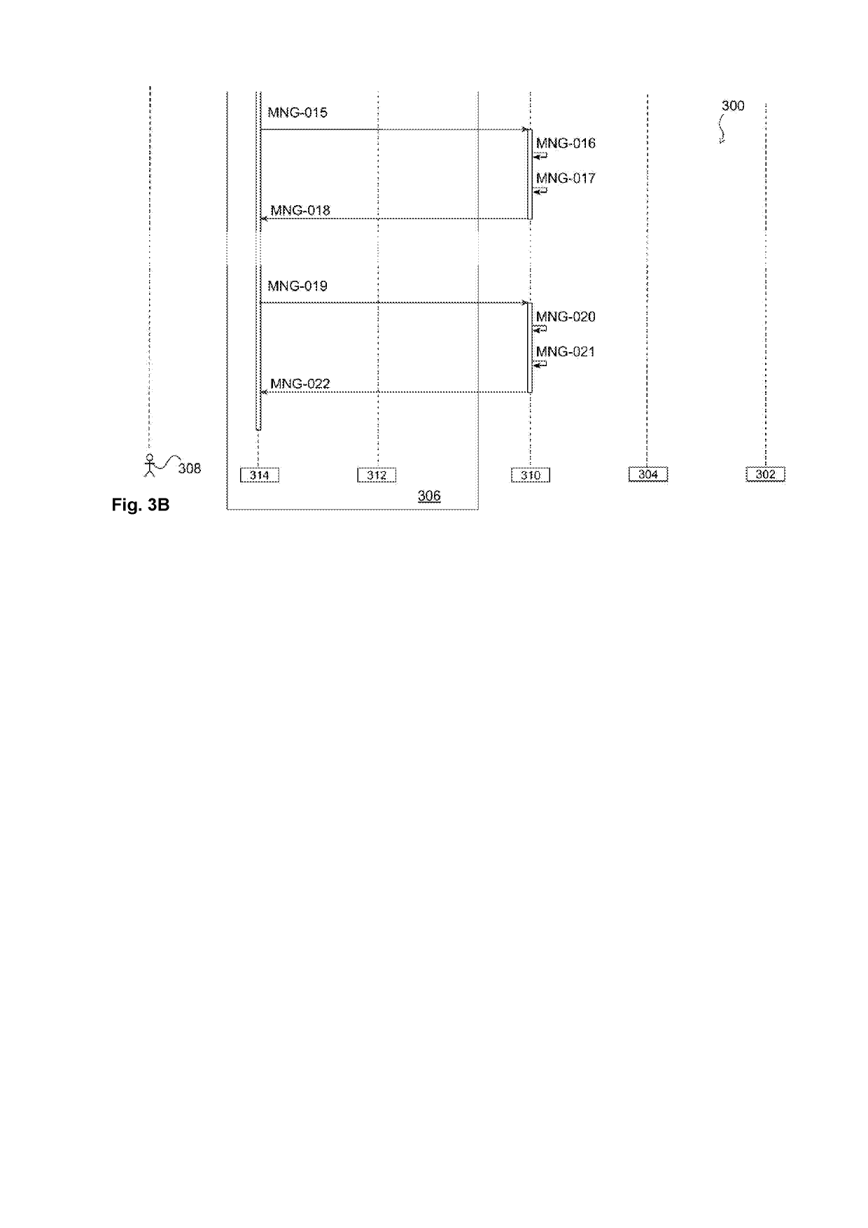

FIGS. 3A and 3B collectively illustrate, in the form of a schematic sequence diagram, a further exemplary embodiment of a method 300 for controlling an access to a motor vehicle 302 wherein, according to the method 300, a backend application or, in general, a key management function 304 for the vehicle 302, a mobile device 306 of a user 308 and the smartcard 310 interact. The method 300 relates to an administrative access to a digital vehicle key for the motor vehicle 302, which key is saved on the memory card 310. The mobile device comprises an application and/or a wallet 314 wherein, on occasions hereinafter, reference is only made to the “app” 314 for short.

A first part of the method 300 relates to an authorization for an administration of an endpoint on the smartcard 310. Specifically, in a step MNG-001, an input of the user 308 on the app 314 is executed, which input relates to an editing of properties of an endpoint, or to a deletion of an endpoint. In a step MNG-002, a command message with respect to an administrative access to the endpoint (or to the digital vehicle key which is represented thereby) is transmitted to the smartcard 310 for the vehicle 302. The command message can relate to a specific command for authorization such as, for example, an APDU “AUTHORIZE ENDPOINT MANAGEMENT REQUEST”. The command message can communicate an index or index value, and or a value or an ID (identifier), by means of which the endpoint is unequivocally identified.

In the smartcard 310, the command message is received, and is interpreted as a request for an authorization test (challenge). Specifically, in a step MNG-003, the smartcard 310 outputs a test of this type in the form of a nonce, which nonce is signed by a cryptographic key on the part of the card 310. In a step MNG-004, the signed test is returned, together with a chain of trust.

According to a specific exemplary embodiment, the app 314, in a step MNG-005 transmits a request message with respect to a signature of the signed test which is received by the smartcard 310 to the secure element 312 of the mobile device 306. In a step MNG-006, the signed test is signed using a digital key which is saved in the secure element 312, i.e. for example using a device key. In a step MNG-007, the secure element 312 returns the signature, together with a chain of trust relating to the device key, to the app 314.

In a step MNG-008, the app 314 transmits a request message with respect to an authorization to the backend or key management application 304. The request message communicates the signed test and the associated chain of trust, as received from the smartcard in step MNG-004 and, moreover, the signature of the device key and the associated chain of trust, as received from the secure element 312.

In a step MNG-009, the key management application 304 checks the signed test thus received, including the associated chain of trust, vis-à-vis a saved certificate with respect to the smartcard 310. In a step MNG-010, the key management function 304 checks the signature with respect to the device key which is saved in the secure element 312, including the associated chain of trust.

According to an alternative exemplary embodiment, the app 314, in a step MNG-011, transmits a request message with respect to an authorization to the backend or key management application 304. The request message communicates the signed test, together with the associated chain of trust, as obtained from the smartcard in step MNG-004. In a step MNG-012, the key management application 304 checks the signed test thus received, including the associated chain of trust, vis-à-vis a saved certificate with respect to the smartcard 310.

In a step MNG-013, the key management application 304 signs the signed test, i.e. the key management application 304 applies an additional signature from the backend or key management application 304. In a step MNG-014, the test, including the two signatures thus assigned and an associated chain of trust, are returned to the app 314 in the mobile device 306.

A further element of the method 300 relates to an authorization of an endpoint administration, wherein a response to the test is delivered to the smartcard 310. Specifically, the app 314 on the mobile device, in a step MNG-015, transmits a response message with respect to administrative access to the endpoint, or to the digital vehicle key which is represented thereby, to the smartcard 310. The response message can be, for example, an APDU “AUTHORIZE ENDPOINT MANAGEMENT RESPONSE”, or similar. The command message can include a further communication of the index communicated in step Schritt MNG-002 and, moreover, the test, including the two signatures thus assigned and the associated chain of trust (as communicated by the key management application 304 in step MNG-014).

In a step MNG-016, the smartcard 310 checks the test thus received, including the two associated signatures and the associated chain of trust, vis-à-vis a saved certificate with respect to the backend or key management application 304. In a step MNG-017, an administration of the relevant endpoint is released for the current session or for the current (NFC) activation cycle. In a step MNG-018, a message with respect to the successful release is returned by the smartcard 310 to the app 314 on the mobile device 306.

Finally, the method 300 relates to an execution of an endpoint administration operation. This administration can involve an editing of the endpoint or a deletion of the endpoint. According to one exemplary embodiment, in a step MNG-019, a command message for deleting an endpoint is transmitted to the smartcard 310, for example an APDU “DELETE ENDPOINT”. The command message can contain the previously communicated index value or identifier. In a step MNG-020, the smartcard 310 executes a check as to whether an administration of the relevant endpoint is enabled. In a step MNG-021, the smartcard 310 executes the requested administration, and deletes the endpoint. In a step MNG-022, a message with respect to the executed or successful administration operation is returned by the smartcard 310 to the app 314 on the mobile device 306.

Exemplary embodiments of the invention provide for technical measures to the effect that an authorized user (i.e. a private user or an administrative user) is enabled to modify a digital vehicle key or a relevant endpoint on their smartcard or memory card. To this end, exemplary embodiments of the invention provide for technical measures to the effect that only predefined administration commands are executable, i.e. according to some exemplary embodiments, it is necessary for each command, prior to the execution thereof, to be successfully verified by a backend management application. Orders which are not “protected” in this manner are dismissed. Specifically, according to exemplary embodiments of the invention, it is provided that a specific command with respect to a specific administrative access is checked by an authority or a backend management application, or that, firstly, a general command for authorization is verified, which general command is then followed by a specific command (from a plurality of authorized commands).

Exemplary embodiments of the invention enable a verification in a backend application wherein, for example, a PKI is provided in the smartcard. This PKI can be incorporated, for example, during production, and a corresponding certificate can be saved in the backend application. Conversely, a certificate with respect to the backend application can be saved in the smartcard. Exemplary embodiments of the invention provide for a message exchange between the smartcard and a backend authority, by means of which, for example, an authorization can be securely confirmed or verified. A mobile device which is employed as a relay station between the smartcard and the backend application can also be verified; more specifically, the mobile device can be verified by way of a device which is enabled for administration (i.e. for a specific administration operation, or for general administration).

A digital vehicle key, or a relevant endpoint on a memory card or smartcard, further to a production phase, can thus be protected against indiscriminate manipulation. The check as to whether a specific command (or a group of commands) is enabled can be executed in a vehicle-side backend application, or by another appropriate party.

Exemplary embodiments of the invention can be implemented in a simple manner, for example by way of an extension or expansion of existing combinations, and are associated with only minimal additional complexity.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Reference symbols

100 System

102 Motor vehicle

104 Backend application

106 Mobile device

108 User

110 Smartcard

112 Secure environment of the mobile device 106

114 User/device key

116 User profile in the backend application 104

118 Secure memory area of the smartcard

120 Endpoint/digital vehicle key

122 Access to the vehicle 102

124 Message exchange (handshake)

126 Root element on the card 110

128 Certificate (of the card 110) in the backend application 104

130 Root element in the backend application 104

132 Certificate (of the backend application 104) on the card 110

134 User input

136 Transmission of a request for authorization

138 Transmission of a forward message

140 Relaying of the forward message

142 Transmission of a return message

144 Relaying of the return message

200 Method in the mobile device 106

202 Transmission of an authorization request

204 Reception of a forward message

206 Relaying of the forward message

208 Reception of the return message

210 Relaying of the return message

212 Reception of authorization

214 Transmission of a command for administrative access

216 Reception of a return message for administrative access

218 Access to the vehicle 102

230 Method in the smartcard 110

232 Reception of an authorization request

234 Transmission of a forward message

236 Reception of a return message

238 Checking of the return signature

240 Transmission of an authorization for administration

242 Reception of a command for administration

244 Transmission of a return message for administration

260 Method in the backend application 104

262 Reception of a forward message

264 Checking of a forward signature

266 Checking of a device signature

268 Transmission of a return message

300 Method

302 Motor vehicle

304 Backend/key management application

306 Mobile device

308 User

310 Smartcard

312 Secure element

314 App/wallet

MNG-001 - MNG-014 Message exchange for authorization

MNG-015 - MNG-018 Authorization in the smartcard 310

MNG-019 - MNG-022 Execution of administrative access 105

What is claimed is:

1. A method for controlling access to a motor vehicle, the method comprising steps of:
transmitting a first command message with respect to administrative access to a digital vehicle key for the motor vehicle, where the key is saved on a memory card;
receiving and relaying of a forward message of a message exchange;
receiving and relaying of a return message of the message exchange; and
receiving a confirmation message with respect to the administrative access executed.

2. The method according to claim 1, wherein the relaying of the forward message comprises:
signing the forward message with a device key, where the key is securely saved on a mobile device.

3. The method according to claim 1, further comprising:
receiving a confirmation message with respect to the message exchange executed; and
transmitting a second command message with respect to the administrative access.

4. A method for controlling access to a motor vehicle, the method comprising steps of:
receiving a first command message with respect to administrative access to a digital vehicle key for the motor vehicle, where the key is saved on a memory card;
transmitting a forward message of a message exchange;
receiving a return message of the message exchange, wherein the return message comprising a return signature;
checking the return signature utilizing a saved certificate; and,
on the basis of the check of the return signature, transmitting a confirmation message with respect to the administrative access executed.

5. The method according to claim 4, wherein the saved certificate is a trusted certificate.

6. The method according to claim 4, wherein:
the forward message comprises a forward signature; and
at least one of:
the forward message contains a forward chain of trust; or
the forward signature relates to a signed nonce.

7. The method according to claim 4, wherein the return message comprises a return chain of trust, and the checking of the turn signature comprises a check of the return chain of trust.

8. The method according to claim 4, further comprising:
transmitting a confirmation message with respect to an authorization for the administration of an endpoint; and
receiving a second command message with respect to an administration of the endpoint, where the message relates to the digital vehicle key.

9. A method for controlling access to a motor vehicle, the method comprising the steps:
receiving a forward message of a message exchange, wherein the message exchange relates to an administrative access to a digital vehicle key for the motor vehicle, wherein the digital vehicle key is saved on a memory card, and wherein the forward message comprises a forward signature;
checking the forward signature utilizing a saved certificate with respect to the memory card; and,
on the basis of the check of the forward signature, transmitting a return message of the message exchange.

10. The method according to claim 9, wherein the saved certificate is a trusted certificate.

11. The method according to claim 9, wherein:
the return message comprises a return signature; and
at least one of:
the return message comprises a return chain of trust; and
the return signature relates to a signed nonce.

12. A mobile device configured to control an access to a motor vehicle, the mobile device comprising one or more processes configured to execute the method according to claim 1.

13. A memory card configured to control access to a motor vehicle, the memory card comprising one or processors configured to execute the method according to claim 4.

14. A computer-readable storage medium comprising a set of instruction that when executed by a processor cause the processor to control access to a motor vehicle according to the method of claim 9.

15. A system configured to control access to a motor vehicle, comprising:
the vehicle, which is configured for saving a digital vehicle key;
a mobile device configured to control an access to the motor vehicle, the mobile device comprising one or more processes configured to execute a method comprising the steps of:
transmitting a first command message with respect to administrative access to a digital vehicle key for the motor vehicle, where the key is saved on a memory card;
receiving and relaying of a forward message of a message exchange;
receiving and relaying of a return message of the message exchange; and
receiving a confirmation message with respect to the administrative access executed;
at least one memory card configured to control access to a motor vehicle, the memory card comprising one or processors configured to execute a method comprising the steps of:
receiving a first command message with respect to administrative access to a digital vehicle key for the motor vehicle, where the key is saved on a memory card;
transmitting a forward message of a message exchange;
receiving a return message of the message exchange, wherein the return message comprising a return signature;
checking the return signature utilizing a saved certificate; and,
on the basis of the check of the return signature, transmitting a confirmation message with respect to the administrative access executed; and
a computer-readable storage medium comprising a set of instruction that when executed by a processor cause the processor to control access to a motor vehicle according to a method comprising the steps of:
receiving a forward message of a message exchange, wherein the message exchange relates to an administrative access to a digital vehicle key for the motor vehicle, wherein the digital vehicle key is saved on a memory card, and wherein the forward message comprises a forward signature;
checking the forward signature utilizing a saved certificate with respect to the memory card; and,
on the basis of the check of the forward signature, transmitting a return message of the message exchange.
